(19) United States
(12) Patent Application Publication
(10) Pub. No.: US 2014/0361778 A1
(43) Pub. Date: Dec. 11, 2014

(54) APPARATUS AND METHODS FOR MEASURING SPONTANEOUS POTENTIAL OF AN EARTH FORMATION

(71) Applicant: SCHLUMBERGER TECHNOLOGY CORPORATION, Sugar Land, TX (US)

(72) Inventors: MIN-YI CHEN, BOUNTIFUL, UT (US); JEFFREY A. TARVIN, CAROLINA BEACH, NC (US); ÉTIENNE LAC, CAMBRIDGE, MA (US); ANDREW CASTON, SOMERVILLE, MA (US)

(21) Appl. No.: 13/912,133

(22) Filed: Jun. 6, 2013

(51) Int. Cl. G01V 3/26; G01V 3/04

(52) U.S. Cl. CPC G01V 3/265; G01V 3/04
USPC 324/351

(57) ABSTRACT

An apparatus for measuring spontaneous potential (SP) of an earth formation includes a downhole tool that is moveable within a borehole by conveyance means. A portion of the conveyance means produces a reference DC potential signal. The tool includes a measurement electrode that produces a potential signal representative of SP of the earth formation. The tool also includes circuitry that measures a differential DC potential signal between the potential signal produced by the measurement electrode and the reference DC potential signal. SP data that characterizes SP of the earth formation is generated based upon the output of such circuitry. In one embodiment for a while-drilling tool, the conveyance means and tool are realized by a drill string with an insulative sleeve that supports the measurement electrode and electrically isolates the measurement electrode from the drill string. Other embodiments for while-drilling tools and tools for tough logging conditions are also described.

### BACKGROUND

1. Field

The present application relates broadly to the hydrocarbon industry. More particularly, this application relates to apparatus and methods for measuring spontaneous potential of an earth formation traversed by a borehole.

2. Related Art

Spontaneous potential (SP) is naturally occurring (static) electrical potential in the earth. Spontaneous potential is usually caused by charge separation in clay or other minerals, by the presence of a semipermeable interface impeding the diffusion of ions through the pore space of rocks, or by natural flow of a conducting fluid (salty water) through the rocks. Variations in spontaneous potential can be measured in wellbores to determine variations of ionic concentration in pore fluids of rocks. The magnitude of the spontaneous potential depends mainly on the salinity contrast between the drilling mud and formation water and the clay content of the permeable bed. Spontaneous potential is not measured when a nonconductive drilling fluid (or air) is present in the wellbore. The measurement of spontaneous potential in a wellbore as a function of location (typically referred to as an SP log) is used to detect permeable beds and to estimate formation water salinity and formation clay content.

Specifically, the salinity of the borehole fluid and the salinity of the fluid in the rock formation are often different in a well. Ionic diffusion occurs when the salinities are different. Cations and anions diffuse at different speeds to create a net diffusion current. The diffusion current is the source of the spontaneous potential. In clean sand, anions diffuse faster than cations, whereas cations diffuse faster in shale and shaly sand. Therefore, the SP log can be used to distinguish between sand and shale and is useful in the interpretation of shaly sand formations.

Wireline tools measure spontaneous potential by measuring the DC voltage difference between a downhole electrode on an insulated section of the wireline tool and a reference electrode located on the surface. To make such a measurement, it is necessary to have a conductive wire connecting the electronics (i.e., the digital voltmeter) of the wireline tool to the surface-located reference electrode. In the drill string, there is no such wire that can conduct DC current (voltage); therefore, there is no logging-while-drilling (LWD) tool that measures spontaneous potential. Under tough logging conditions (TLC), a wireline logging tool can be conveyed downhole by a drill string. The drill string typically does not carry a wire that conducts DC current (voltage), and thus such TLC tools do not measure spontaneous potential.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments are provided for a downhole apparatus for measuring spontaneous potential of an earth formation traversed by a borehole. The apparatus includes a downhole tool that is moveable within the borehole by tool conveyance means. A portion of the tool conveyance means produces a reference DC potential signal. The downhole tool includes a measurement electrode and downhole voltage measurement circuitry. The measurement electrode produces a potential signal representative of spontaneous potential of the earth formation adjacent the measurement electrode. The downhole voltage measurement circuitry is configured to measure a differential DC potential signal between the potential signal produced by the measurement electrode and the reference DC potential signal produced by the tool conveyance means portion. The apparatus generates spontaneous potential data that characterizes spontaneous potential of the earth formation adjacent the measurement electrode based upon the differential DC potential signal measured by the voltage measurement circuitry.

In one embodiment, the tool is a while-drilling tool where both the tool conveyance means and the downhole tool are realized by a drill string that drives a drill bit. The drill string includes an insulative sleeve that supports the measurement electrode and that electrically isolates the measurement electrode from a portion of the drill string that produces the reference DC potential signal. Both the measurement electrode and the insulating sleeve can be annular in shape.

In another embodiment, the tool is a while-drilling tool where both the tool conveyance means and the downhole tool are realized by a drill string that drives a drill bit. The drill string comprises a first portion electrically isolated from a second portion, where the first portion is disposed behind the second portion. The first portion produces the reference DC potential signal, and the measurement electrode is realized by the second portion. The first portion can be electrically isolated from the second portion by first and second insulative joints disposed on opposed ends of the second portion. The first insulative joint can electrically isolate the second portion of the drill string from the first portion of the drill string (as well as other parts of drill string disposed behind the first portion). The second insulative joint can electrically isolate the second portion from the other parts of the tool (such as the drill bit) that are disposed forward relative to the second portion of the drill string. Alternatively, the first portion can be electrically isolated from the second portion by a unitary insulative joint. In this case, the drill bit (and possibly other parts of the tool disposed forward relative to the unitary insulative joint) can be part of the measurement electrode.

In yet another embodiment, the tool is a wireline logging tool for tough logging conditions where the tool conveyance means comprises a drill string that supports a wireline tool body. The measurement electrode is supported on the wireline tool body. In this embodiment, the tool body can include an insulative sleeve that supports the measurement electrode and electrically isolates the measurement electrode from the wireline tool body.

The apparatus can include data processing circuitry for generation, storage and output of spontaneous potential data that characterizes spontaneous potential of the earth formation adjacent the measurement electrode at different locations in the borehole, where the spontaneous potential data is based upon the differential DC potential signal measured by said voltage measurement circuitry. The data processing circuitry can also be configured to process the data representing the differential DC potential signals measured by the downhole voltage measurement circuitry with a model that compensates for variations in such differential DC potential signals as compared to traditional spontaneous potential measurements with wireline logging tools that utilize a surface-located reference electrode.

Additional objects and advantages will become apparent to those skilled in the art upon reference to the detailed description taken in conjunction with the provided figures.

### BRIEF DESCRIPTION OF THE DRAWINGS

FIG. 1 is a schematic diagram of an exemplary logging-while-drilling tool that can be adapted with capabilities for acquiring spontaneous potential measurements during drilling, pausing, tripping or other operations in accordance with the embodiments described herein; the logging-while-drilling tool is drilling a borehole through an earth formation.

FIG. 2 is a schematic diagram of an exemplary embodiment of the bottom portion of logging-while drilling tool of FIG. 1, which includes capabilities for acquiring spontaneous potential measurements during drilling, pausing, tripping or other operations.

FIG. 3 is a plot of resistivity (resistivity log) of an earth formation traversed by a borehole as a function of depth in the borehole as measured by a downhole logging tool.

FIG. 4 shows two plots, the first plot represents measurements of spontaneous potential (SP log) of an earth formation in Cartoosa, Okla., traversed by a test well borehole (Cartoosa test well) as a function of depth in the borehole as measured by a wireline logging tool, and the second plot represents the source of spontaneous potential across the mud invasion front of the Cartoosa test well borehole as derived from inversion of the SP log of the first curve.

FIG. 5 shows two plots for the curves of FIG. 4 in an expanded scale for a depth interval between 1250 feet and 1300 feet of the Cartoosa test well borehole.

FIG. 6 shows two plots, the first plot represents predictions of the spontaneous potential measurements (predicted while-drilling SP log) of the earth formation traversed by the Cartoosa test well borehole as a function of depth in the borehole as acquired by modeling the tool of FIG. 2 during drilling, and the second plot represents measurements of spontaneous potential (SP log) of the earth formation traversed by the Cartoosa test well borehole as a function of depth in the borehole as measured by a wireline logging tool (the same as the second curve of FIG. 4).

FIG. 7 shows two plots for the curves of FIG. 6 in an expanded scale for a depth interval between 260 feet and 360 feet of the Cartoosa test well borehole.

FIG. 8 shows two plots for the curves of FIG. 6 in an expanded scale for a depth interval between 520 feet and 620 feet of the Cartoosa test well borehole.

FIG. 9 shows two plots for the curves of FIG. 6 in an expanded scale for a depth interval between 850 feet and 950 feet of the Cartoosa test well borehole.

FIG. 10 shows two plots for the curves of FIG. 6 in an expanded scale for a depth interval between 950 feet and 1250 feet of the Cartoosa test well borehole.

FIG. 11 shows two plots, the first plot represents predictions of the spontaneous potential measurements (predicted while-drilling SP log) of the earth formation traversed by the Cartoosa test well borehole as a function of depth in the borehole as acquired by modeling of the tool of FIG. 2 during drilling, and the second plot represents predictions of the spontaneous potential measurements (predicted while-tripping SP log) of the earth formation traversed by the Cartoosa test well borehole as a function of depth in the borehole as acquired by modeling of the tool of FIG. 2 during tripping.

FIG. 12 shows two plots for the curves of FIG. 11 in an expanded scale for a depth interval between 510 feet and 520 feet of the Cartoosa test well borehole.

FIG. 13 shows two plots, the first curve represents predictions of the spontaneous potential measurements (predicted while-drilling SP log) of the earth formation traversed by the Cartoosa test well borehole as a function of depth in the borehole as acquired by modeling of the tool of FIG. 2 during drilling where the voltage potential sources are doubled in the 30 feet of the borehole just above the drill bit, and the second curve represents predictions of the spontaneous potential measurements (predicted while-drilling SP log) of the earth formation traversed by the Cartoosa test well borehole as a function of depth in the borehole as acquired by modeling the tool of FIG. 2 during drilling (the same as the curve of FIG. 6).

FIG. 14 is a schematic diagram of another exemplary embodiment of the bottom portion of logging-while drilling tool of FIG. 1, which includes capabilities for acquiring spontaneous potential measurements during drilling, pausing, tripping or other operations.

FIG. 15 shows two plots, the first plot represents predictions of the spontaneous potential measurements (predicted while-drilling SP log) of the earth formation traversed by the Cartoosa test well borehole as a function of depth in the borehole as acquired by modeling the tool of FIG. 14 during drilling, and the second plot represents measurements of spontaneous potential (SP log) of the earth formation traversed by the Cartoosa test well borehole as a function of depth in the borehole as measured by a wireline logging tool (the same as the curve of FIG. 4).

FIG. 16 shows two plots, the first curve represents predictions of the spontaneous potential measurements (predicted while-drilling SP log) of the earth formation traversed by the Cartoosa test well borehole as a function of depth in the borehole as acquired by modeling of the tool of FIG. 14 during drilling where the voltage potential sources are doubled in the 30 feet of the borehole just above the drill bit, and the second curve represents predictions of the spontaneous potential measurements (predicted while-drilling SP log) of the earth formation traversed by the Cartoosa test well borehole as a function of depth in the borehole as acquired by modeling the tool of FIG. 14 during drilling (the same as the curve of FIG. 15).

FIG. 17 is a schematic diagram of yet another exemplary embodiment of the bottom portion of logging-while drilling tool of FIG. 1, which includes capabilities for acquiring spontaneous potential measurements during drilling, pausing, tripping or other operations.

FIG. 18 shows two plots, the first plot represents predictions of the spontaneous potential measurements (predicted while-drilling SP log) of the earth formation traversed by the Cartoosa test well borehole as a function of depth in the borehole as acquired by modeling the tool of FIG. 17 during drilling, and the second plot represents measurements of spontaneous potential (SP log) of the earth formation traversed by the Cartoosa test well borehole as a function of depth in the borehole as measured by a wireline logging tool (the same as the curve of FIG. 4).

FIG. 19 is a schematic diagram of the bottom portion of a wireline logging tool, which includes capabilities for acquiring spontaneous potential measurements in tough logging conditions in accordance with the present application.

### DETAILED DESCRIPTION

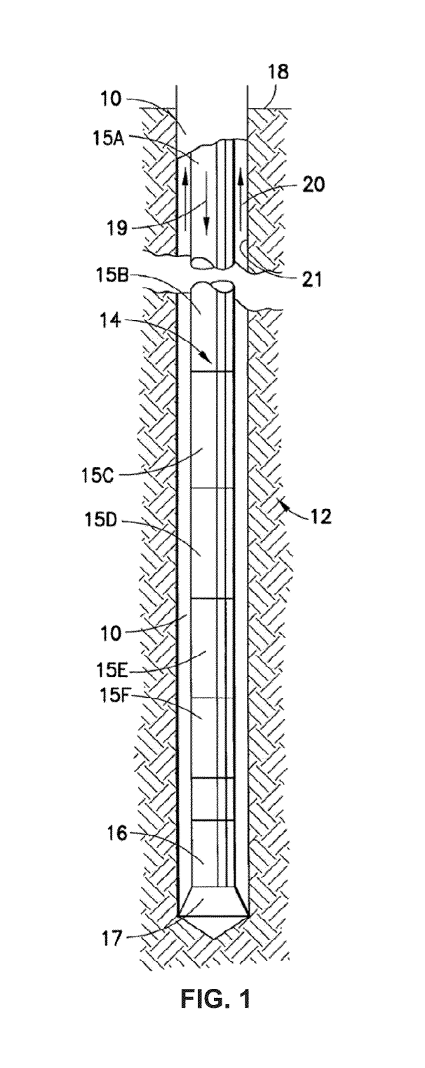

Turning now to FIG. 1, a schematic illustration of a borehole 10 drilled into a formation 12 by a rotary drilling apparatus that employs a while-drilling spontaneous potential measurement tool in accordance with the present application. The drilling apparatus includes a drill string 14 composed of a number of interconnected tubular sections (commonly referred to as “drill pipe” and shown as six sections 15A, 15B, 15C, 15D, 15E, 15F) supporting at their lower end at least one drill collar (one shown as 16). The terminal drill collar of the drill string 14 is mechanically coupled to a drill bit 17. At the surface, the drill string 14 is supported and rotated by standard apparatus (not shown), thereby rotating the drill bit 17 to advance the depth of the borehole 10.

A recirculating flow of drilling fluid or mud is utilized to lubricate the drill bit 17 and to convey drill tailings and debris to the surface 18. Accordingly, the drilling fluid is pumped down the borehole 10 and flows through the interior of the drill string 14 (as indicated by arrow 19), and then exits via ports (not shown) in the drill bit 17. The drilling fluid exiting the drill bit 17 circulates upward (as indicated by arrows 20) in the region between the outside of the drill string 14 and the periphery 21 of the borehole 10, which is commonly referred to as the annulus.

In accordance with the present application, the drill string 14 of FIG. 1 includes capabilities of measuring spontaneous potential as described below in more detail. The measurements are observed in the borehole 10 with the drill string 14 located in the borehole during drilling, pausing, tripping, or other operations.

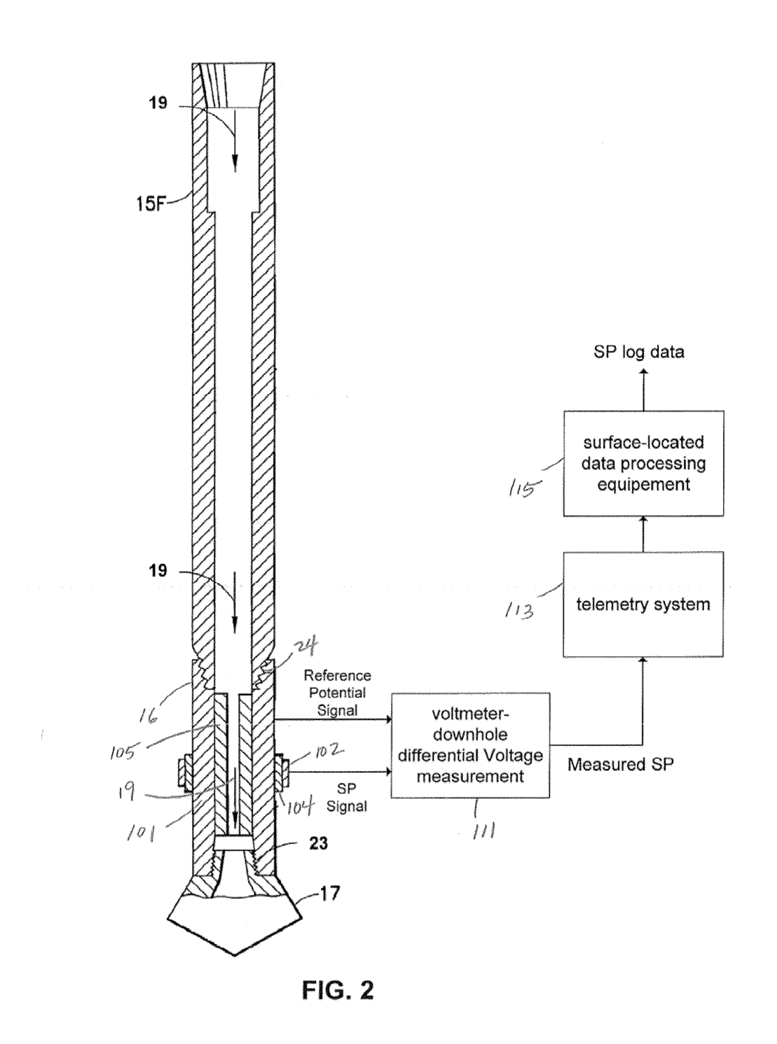

As shown in the cross-section of FIG. 2, the bottom portion of the drill string 14 includes a series of interconnected elements including the tubular section 15F, the at least one drill collar 16, and the drill bit 17. The drill bit 17 is interconnected to the bottom of the drill collar 16 by a threaded coupling 23. The drill collar 16 includes a thick-walled metal tubular body 101. The weight of the metal tubular body 101 of the drill collar 16 can be used to apply weight onto the bit 17. Multiple drill collars 16 can be joined together for this purpose. The top of the at least one drill collar 16 is interconnected to the bottom of the tubular section 15F by a threaded coupling 24 as shown.

The at least one drill collar 16 includes a measurement electrode 102 (preferably annular in shape) supported on an insulating sleeve 104 (also preferably annular in shape) that surrounds or otherwise overlies the thick-walled metal tubular body 101 of the drill collar 16. The insulating sleeve 104 is realized from an electrically insulating material [such as a high temperature fiberglass, ceramics (e.g., zirconia and/or transformation toughened zirconia (TTZ)), high temperature thermoplastic (e.g., PEEK, PEKK, virgin, or fiber-reinforced), epoxy paint, rubber and/or hybrid combinations of these materials (metamaterials)] that is suitable for the while-drilling borehole environment. The insulating sleeve 104 electrically isolates the measurement electrode 102 from the metal tubular body 101 of the drill collar 16 and thus allows the metal tubular body 101 to be used to generate a reference DC potential signal for spontaneous potential measurements as described below in more detail. The reference DC potential signal is generally static in nature due to the large conductive mass of the metal tubular body 101 and its ability to source or sink charge without changing its potential.

In one embodiment, an annular chassis 105 fits within the drill collar 16. The annular chassis 105 houses insulated conductive wiring that is electrically coupled via insulated feed-throughs (not shown) to the electrode 102 (which is used as a measuring electrode for spontaneous potential measurements) and to the metal tubular body 101 of the drill collar (which is used to generate a reference DC potential signal for spontaneous potential measurements). The drilling fluid flows through the center of the annular chassis 105 as shown by the arrow 19. The annular chassis 105 also preferably includes interface electronics and telemetry electronics which interface to a while-drilling telemetry system (such as a mud pulse telemetry system or electromagnetic (EM) frequency communication telemetry system) located in a separate drill collar (or possibly the same drill collar). The interface electronics includes a digital voltmeter (labeled as block 111 in FIG. 2) whose inputs are connected to the insulated conductive wirings leading to the measurement electrode 102 and to the metal tubular body 101 of the drill collar. The digital voltmeter 111 is configured to measure the differential DC voltage (current) between the measurement electrode 102 and the reference potential DC signal provided by the metal tubular body 101. Such differential voltage measurement (labeled “measured SP” in FIG. 2) is representative of the sum of the voltages from ionic diffusion (spontaneous potential) of the earth formation at the measurement electrode 102 and possibly voltages from fluid movement (streaming potential) at the measurement electrode 102. The telemetry electronics of the chassis 105 supplies the measured SP data to the telemetry system (labeled as block 113 in FIG. 2), which communicates the measured downhole data to surface-located data processing equipment 115 (e.g., a processor and associated data storage). For example, mud pulse telemetry generates oscillating pressure waves that propagate upwards inside the drill string 14 and which are detected by a pressure sensor mounted on the drilling rig. The telemetry system 113 encodes the downhole measurements (including the measured SP data), which are decoded by the surface-located data processing equipment 115. The surface-located data processing equipment 115 receives data signals representative of the downhole measurements (including the measured SP data) and processes the data signals representative of the measured SP data to derive a spontaneous potential (SP) log data for storage and analysis. The SP log data can be derived from the differential voltage measurements performed by the voltmeter 111 that are observed in the borehole 10 with the drill string 14 located in the borehole during drilling, pausing, tripping, or other operations.

The operations of the while-drilling SP tool of FIG. 2 can be studied by inverse modeling of SP log data acquired by a wireline tool from a test well. More specifically, the wireline SP log data can be inverted to SP source data across the invasion front. The SP source data can represent static spontaneous potential (SSP) which is the ideal spontaneous potential across a clean (shale free) permeable bed. The inversion algorithm is straightforward. Forward modeling techniques can be used to compute the response of the wireline tool to a unit dipole source placed at a given depth point in the invasion front. The computed response is the unit response function of the source at the depth point. The measured SP log data is then fitted as a sum of the computed unit response functions multiplied by the SP source data at the depth point. The best fitting criteria yield a set of linear equations, which can be readily solved for the SP sources across the invasion front.

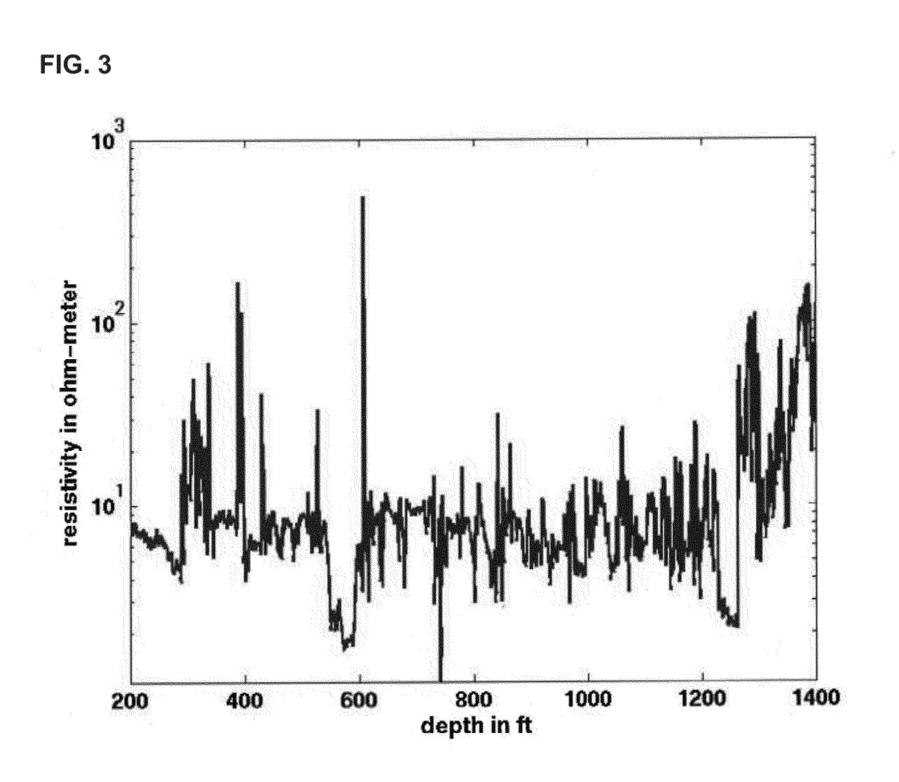

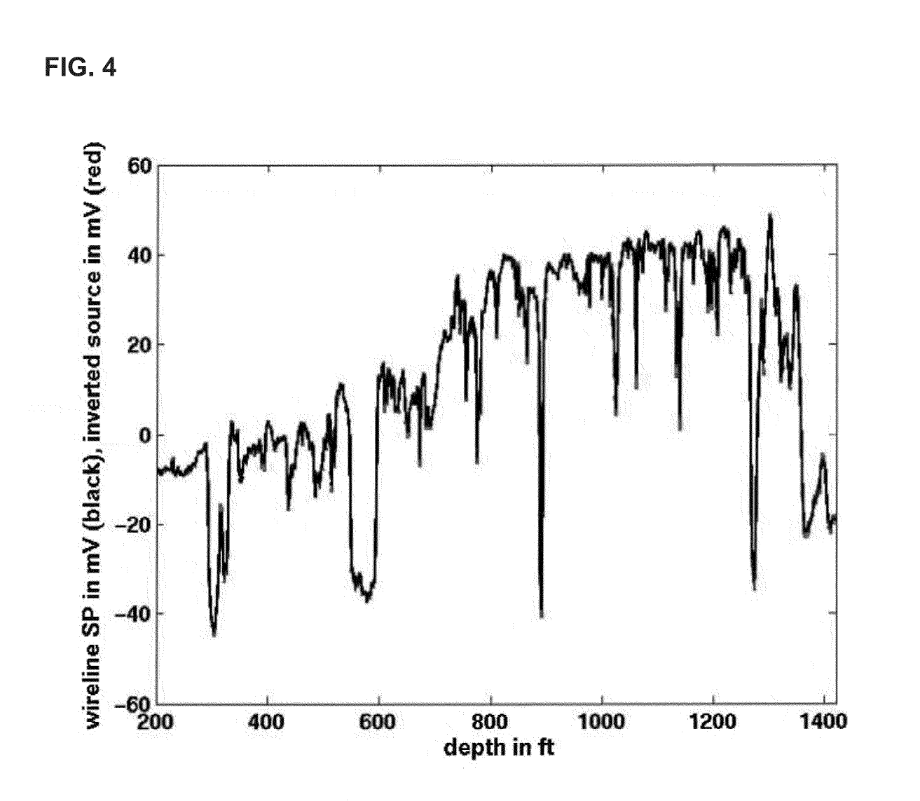

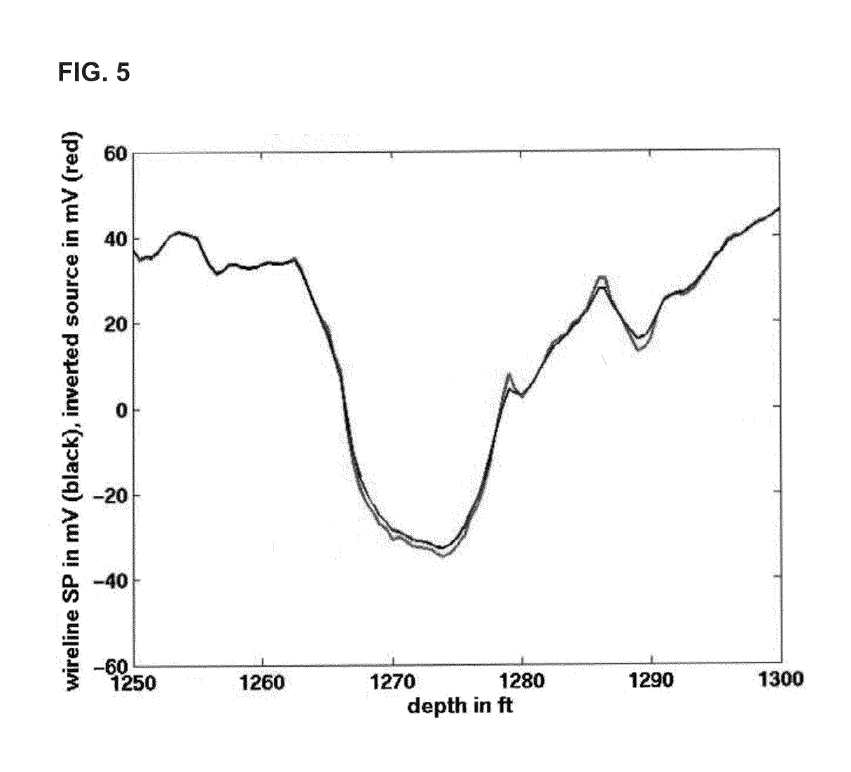

To carry out such an inversion it may be necessary to know the resistivity distribution in the test well. In this case, the mud resistivity can be set according to the drilling mud. In one example for a test well through a hydrocarbon-bearing earth formation in Cartoosa, Okla. (hereinafter referred to as the “Cartoosa test well”), the mud resistivity can be set to 1.33 ohm-meters. The formation resistivity can be taken from a resistivity log (an example of which is shown in FIG. 3). For the case where the invasion of drilling mud into the formation is very shallow, the SP source can be placed near the borehole surface. The invaded zone resistivity is not important. The wireline SP log data is shown as the first curve in FIG. 4, and the inverted SP source (SPP) data is shown as the second curve in FIG. 4. The SP source (SPP) data is almost completely hidden behind the wireline SP log data. Since there is very little invasion in this well, the SP source (SPP) data and the wireline SP log data almost completely overlap. The two data sets are shown in expanded scale for a short interval between 1250 feet and 1300 feet in FIG. 5. It can be seen that the amplitude of the SP source (SPP) data is slightly larger than that of the wireline SP log data, as expected.

Note that in FIG. 4, there is a baseline shift in the wireline SP log data of about 40 mV between the intervals below and above 700 feet. The measured wireline SP log data is the sum of the voltages from ionic diffusion (spontaneous potential) and the voltages from fluid movement (streaming potential). The ionic diffusion voltages depend on the formation water conductivity. If the formation water conductivity changes between different depth intervals, there is a baseline shift in the wireline SP log data. The streaming potential depends on the pressure difference between the formation and the borehole, on the electro-kinetic coupling coefficient of the formation, and on the electro-kinetic coupling coefficient of the mud cake. At wireline logging time, normally the mud cake has been formed uniformly and the pressure in the formation has reached equilibrium. The streaming potential is then simply a constant, and the observed variations in the wireline SP log data are all from voltages from ionic diffusion. Thus, the streaming potential simply contributes to an overall baseline shift. However, in the experimental well of FIG. 4, there was a change of mud during drilling, and the observed baseline shift in the wireline SP log data is likely to have been caused by the change in properties of the mud cakes produced by the different drilling muds. The purpose of the modeling presented here is to demonstrate that the while-drilling tool of FIG. 2 will accurately measure spontaneous potential. In other words, the exact origin of the baseline shift is inconsequential.

Because the while-drilling tool of FIG. 2 is elegant, a small number of parameters are needed to characterize the while-drilling tool. In one embodiment, these parameters include the length of the measurement electrode 102 along the longitudinal dimension of the drill collar, the length of the insulating sleeve 104 along the longitudinal dimension of the drill collar, and the distance between the measurement electrode 102 and the drill bit 17. The length of the measurement electrode 102 along the longitudinal dimension of the drill collar dictates the spatial resolution of the measured SP data. If a six inch resolution is required, the length of the measurement electrode 102 along the longitudinal dimension of the drill collar should be no greater than six inches. The length of the insulating sleeve 104 along the longitudinal dimension of the drill collar should be as long as possible but limited by engineering concerns of the tool. The long length of the insulating sleeve 104 reduces distortion between the measured SP data and the SP measurements by wireline logging tools that utilize the reference DC potential generated at the surface. The separation between the measurement electrode 102 and the drill bit 17 should be large enough such that the streaming potential created by the drilling has little effect on the measured SP data other than a constant baseline shift. If the SP log data is to be acquired during drilling, the measurement electrode 102 should be sufficiently far away from the interval where the mud cake has not yet been well formed. For well-formulated drilling mud, the fluid loss near the drill bit should be stopped very quickly, and a large separation between the measurement electrode 102 and the drill bit 17 is probably not needed. Large separation between the measurement electrode 102 and the drill bit 17 limits the ability of the tool to acquire the SP log data below the position of the measurement electrode 102 when the drill bit 17 is at the bottom of the borehole 10. In one example, the length of the measurement electrode 102 along the longitudinal dimension of the drill collar is set at 2 feet, the length of the insulating sleeve 104 along the longitudinal dimension of the drill collar is set at 6 feet, and the distance between the measurement electrode 102 and the drill bit 17 is set at 60 feet. The SP log data can also be acquired during tripping. In that case, there has been sufficient time for the mud cake to form, and there is no need for large separation between the measurement electrode 102 and the drill bit 17.

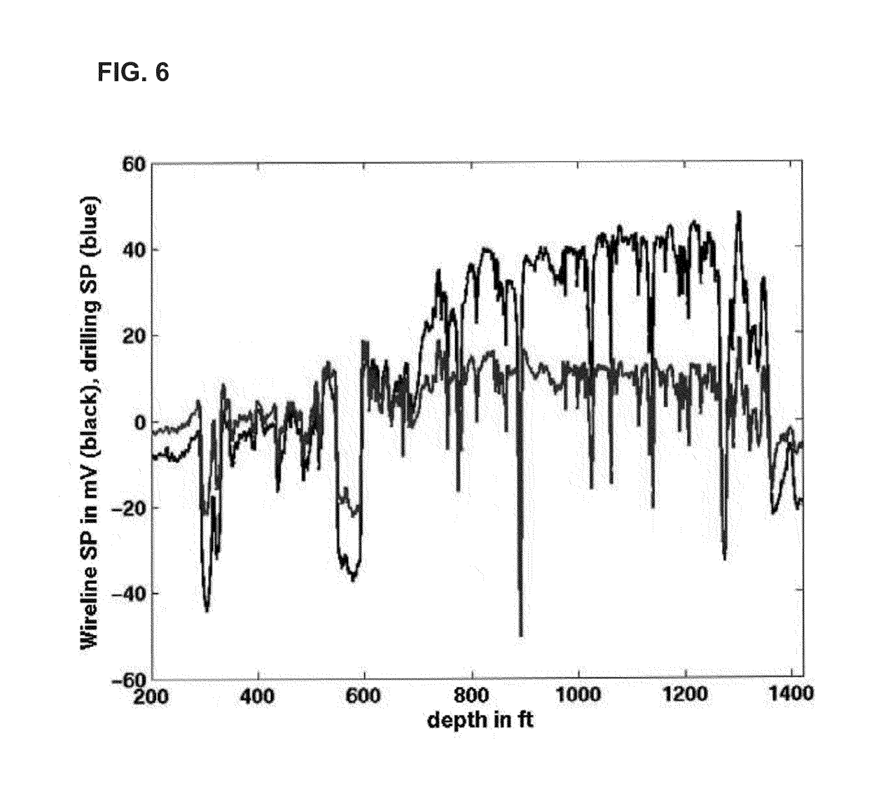

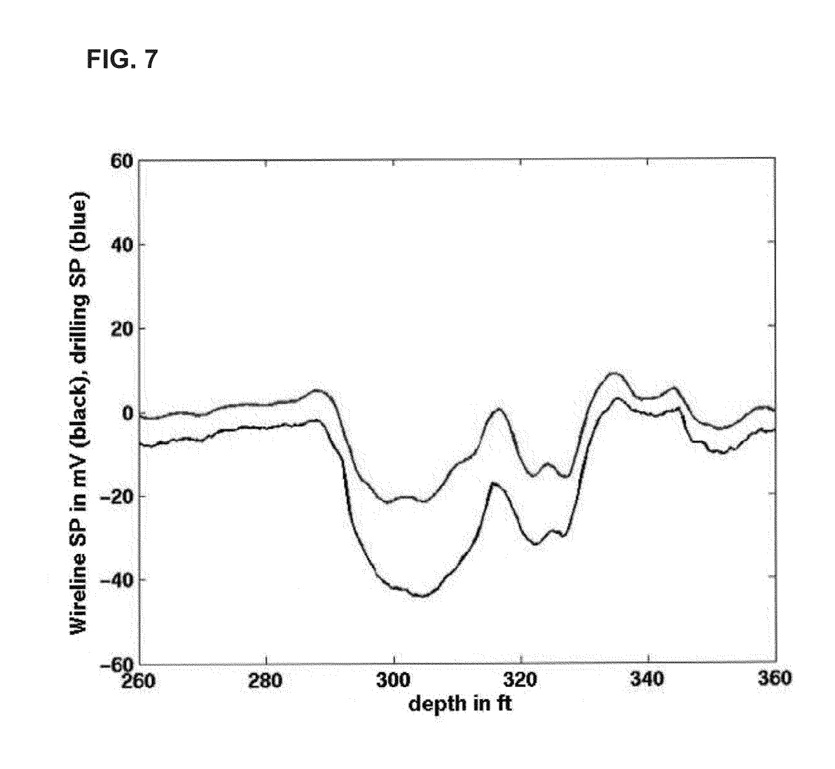

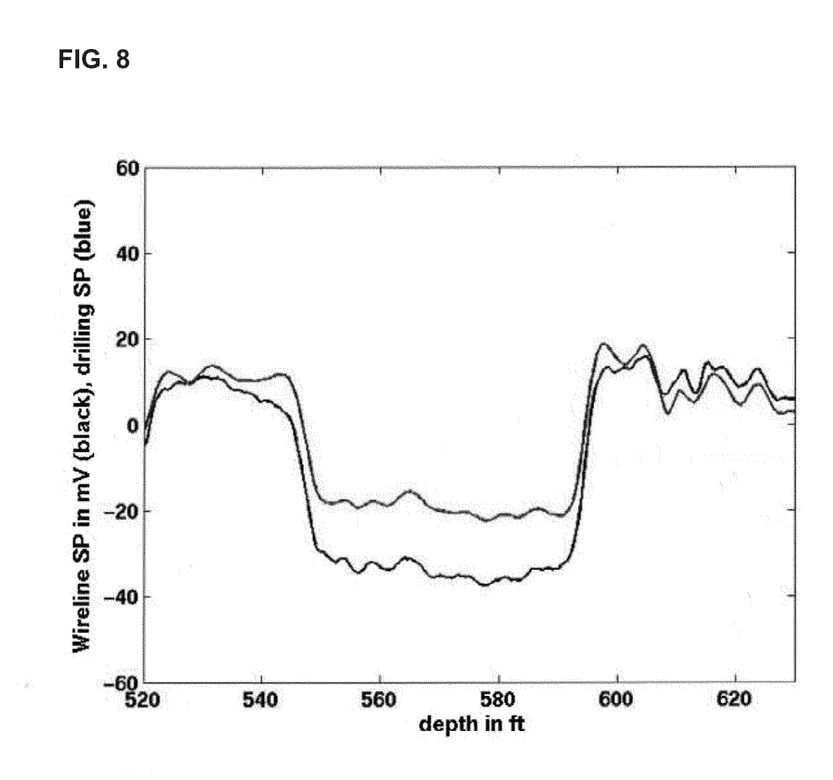

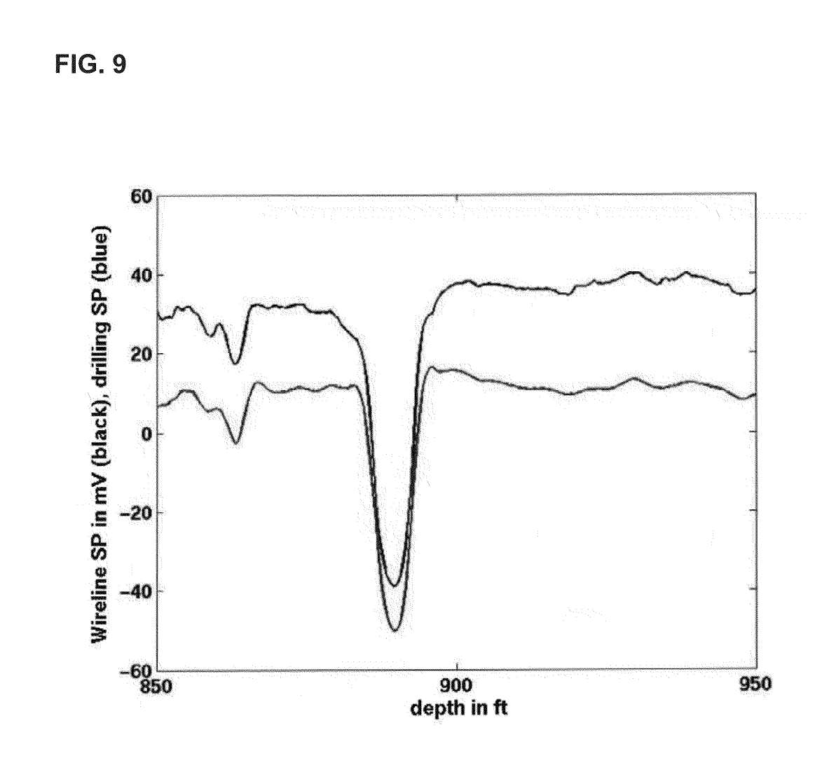

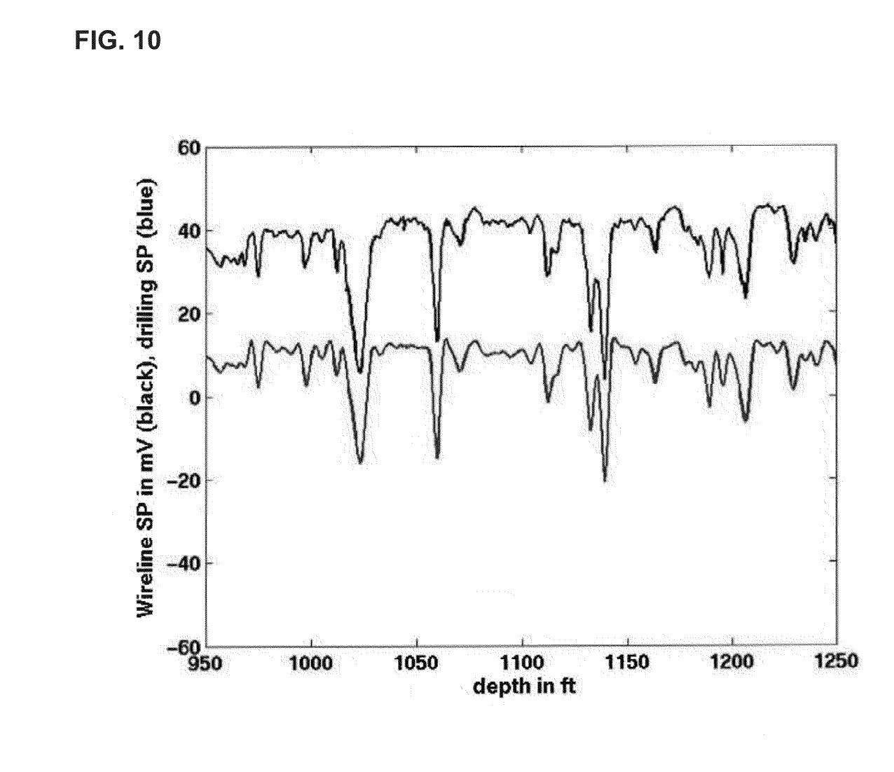

A tool response model can be used to predict the measured SP data that would be acquired while-drilling by the tool of FIG. 2 in the Cartoosa test well. The tool response model can be derived by mathematical modeling and/or empirical measurements. The tool response model can be based on the SP source (SPP) data inverted from the wireline SP log data and the resistivity distribution of the wireline logs. The prediction of the measured SP data while-drilling as output from the tool response model is shown as a curve in FIG. 6 in conjunction with the wireline SP data log shown as the other curve in FIG. 6. The depth for first curve is the position of the measurement electrode 102, not the position of the drill bit 17. Parts of FIG. 6 are shown in expanded scales in FIGS. 7 to 10. It can be seen that the baseline shift of the prediction of the measured SP data while-drilling (first curve) is significantly reduced as compared to the wireline SP data log (second curve). The difference in the baselines of the prediction of the measured SP data while-drilling (first curve) and the wireline SP data log (second curve) is the result of using the body 101 of the drill collar 16 to provide the reference DC potential signal for the measured SP data. It can also be seen from FIGS. 7 to 10 that other than the baseline shift, the prediction of the measured SP data while-drilling (first curve) and the wireline SP data log (second curve) are very close to each other. Specifically, the magnitude of the distortions between the prediction of the measured SP data while-drilling (first curve) and the wireline SP data log (second curve) are quite small. The magnitude of such distortions is related to the length of the insulating sleeve 104; the longer the sleeve 104, the smaller the distortion.

As described above, it is expected that there will be a baseline shift between the measured SP data acquired while-drilling by the tool of FIG. 2 and the wireline SP data log acquired by the wireline tools. The magnitude of this baseline shift depends on the surface properties of the measurement electrode 102, the surface properties of the body 101 of the drill collar 16 that supplies the reference DC potential signal, the electrostatic potential at the surface 18, and the streaming potential from the mud cake. These quantities are usually not known and the overall baseline shift is of no interest during interpretation of the SP data log. The baseline of the SP data log is selected by the log interpreter based on his/her knowledge of the formation. Therefore, the baseline shift between the measured SP data acquired while-drilling by the tool of FIG. 2 and the wireline SP data log acquired by the wireline tools will not normally affect the interpretation. Other than the baseline shift, it is expected that the differences (distortions) between the measured SP data acquired while-drilling by the tool of FIG. 2 and the wireline SP data log acquired by wireline tools would be small in magnitude and not affect the SP data log interpretation. Therefore, it is expected that the measured SP data acquired while-drilling by the tool of FIG. 2 can used directly to derive the SP data log without further processing in many applications.

However, in some applications, it may be desirable to process the measured SP data acquired while-drilling by the tool of FIG. 2 to remove (or significantly reduce) such distortions caused by the finite length of the insulating sleeve 104 and/or to recover the expected baseline shift between two zones of interest. In such applications, the data processing equipment 115 can process the measured SP data acquired while-drilling by the tool of FIG. 2 to compensate for these variations (e.g., distortions and reduced baseline shift) in the differential DC potential signals as compared to traditional spontaneous potential measurements with wireline logging tools that utilize a surface-located reference electrode. In this manner, the SP data log derived from such processing resembles the SP data log acquired by wireline logging tools that utilize a surface-located reference electrode.

In one embodiment, the data processing equipment 115 can employ an inversion process on the measured SP data to achieve removal of distortions and the recovery of the expected baseline shift. This inversion process can be based upon the inversion process used to calculate the SP source (SPP) data at the invasion front from wireline SP logs as described earlier. Forward modeling code can be used to compute the measured SP data acquired while-drilling by the tool of FIG. 2 in response to a unit dipole source placed at a given depth point in the invasion front. The computed response is the unit response function of the source at the depth point. The SP log data is fitted as a sum of the computed unit response functions multiplied by the SP source data for the given depth. The best fitting criteria yield a set of linear equations, which can easily be solved for the data of the SP sources (SPPs) across the invasion front. The unit response function depends on both the position of the unit source on the invasion front and the position of the tool of FIG. 2 in the borehole 10.

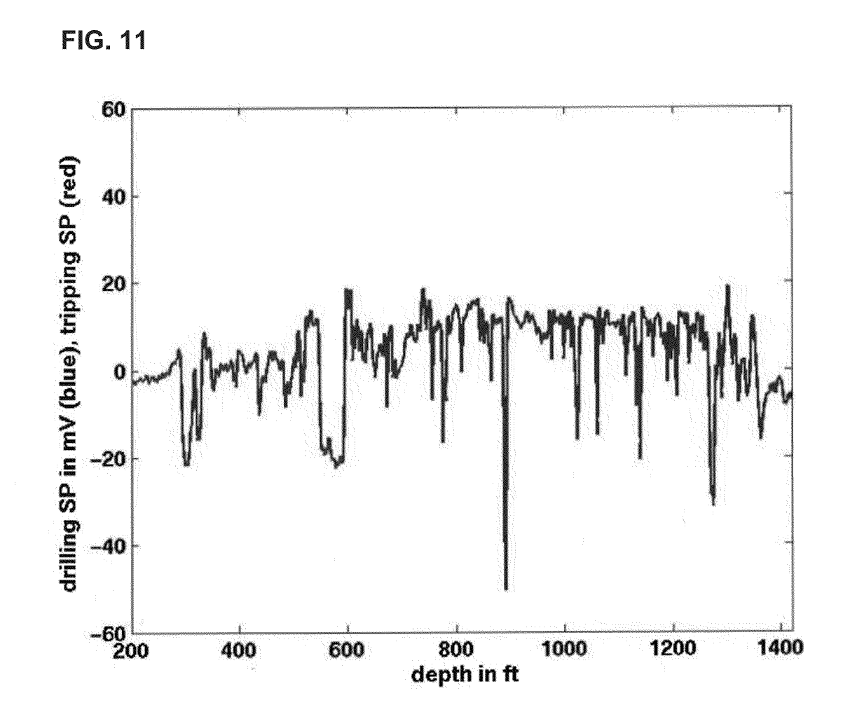

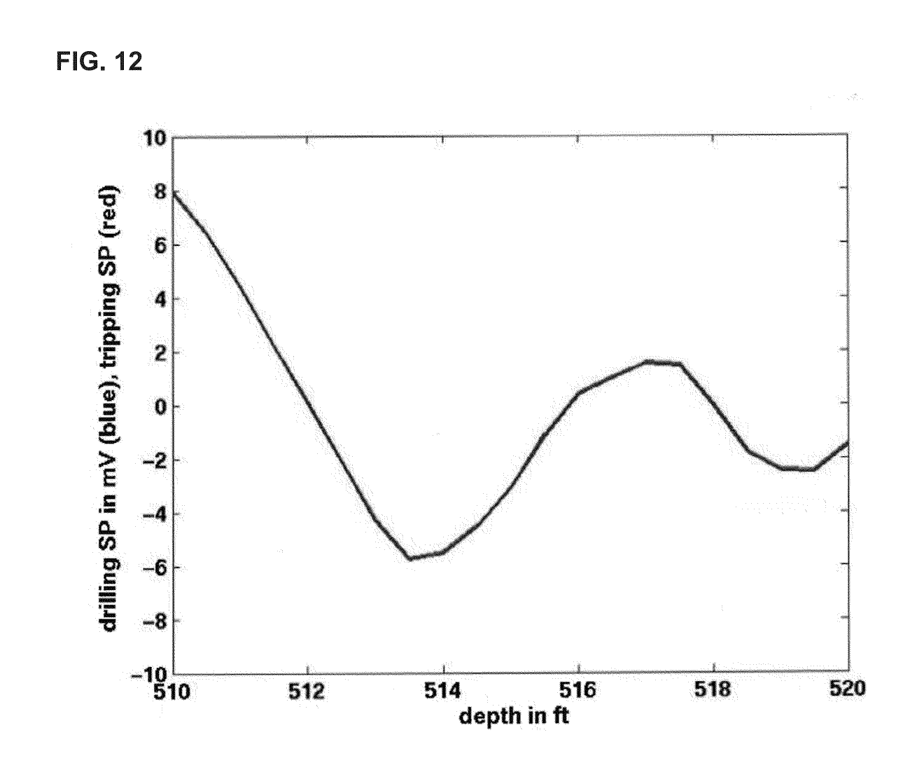

A tool response model can be used to predict the measured SP data that would be acquired while tripping by the tool of FIG. 2 in the Cartoosa test well. The tool response model is similar to the tool response model that predicts the measured SP data that would be acquired while-drilling by the tool of FIG. 2. The difference between the tool response models for tripping and drilling is that for tripping a borehole exists all the way to the bottom, and for drilling the borehole exists only to the depth of the drill bit. In the example described above, the drill bit is positioned 60 feet below the measurement electrode 102. Note that the resistivity of the formation below the drill bit and the SP sources below the drill bit have little effect on the modeling results. The prediction of the measured SP data while tripping as output from the tool response model is shown as a curve in FIG. 11 in conjunction with the prediction of the measured SP data while-drilling shown as the second curve in FIG. 11. The first curve is almost completely hidden indicating that there is no visible difference between the two logs. A part of FIG. 11 is shown in expanded scale in FIG. 12.

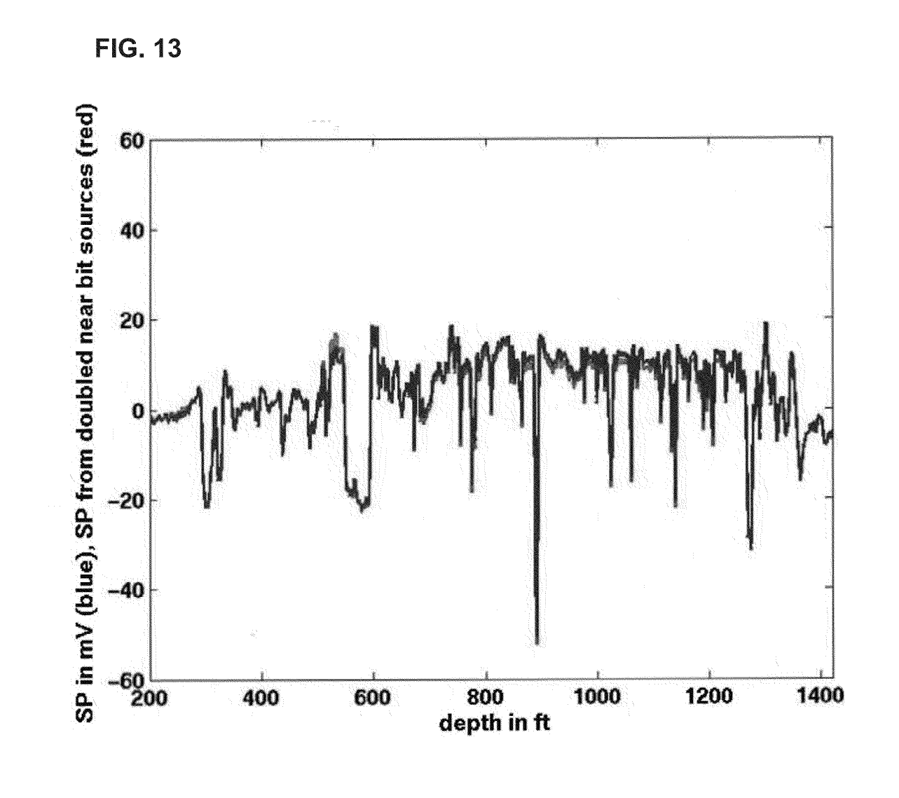

In order to test the sensitivity of the tool of FIG. 2 to voltage potential sources far away from the measurement electrode 102, the tool response model can be modified by doubling the voltage potential sources in the 30 feet of the borehole just above the drill bit. The resulting SP data log for the predicted SP measurements acquired while-drilling by the tool of FIG. 2 for the Cartoosa test well borehole is shown as the first curve in FIG. 13 in conjunction with a second curve (the same as in FIG. 6) which is modeled with sources inverted from wireline SP data log. Note that the first curve is mostly hidden behind the second curve, which shows that little sensitivity can be expected with respect to voltage potential sources in the 30 feet of the borehole just above the drill bit.

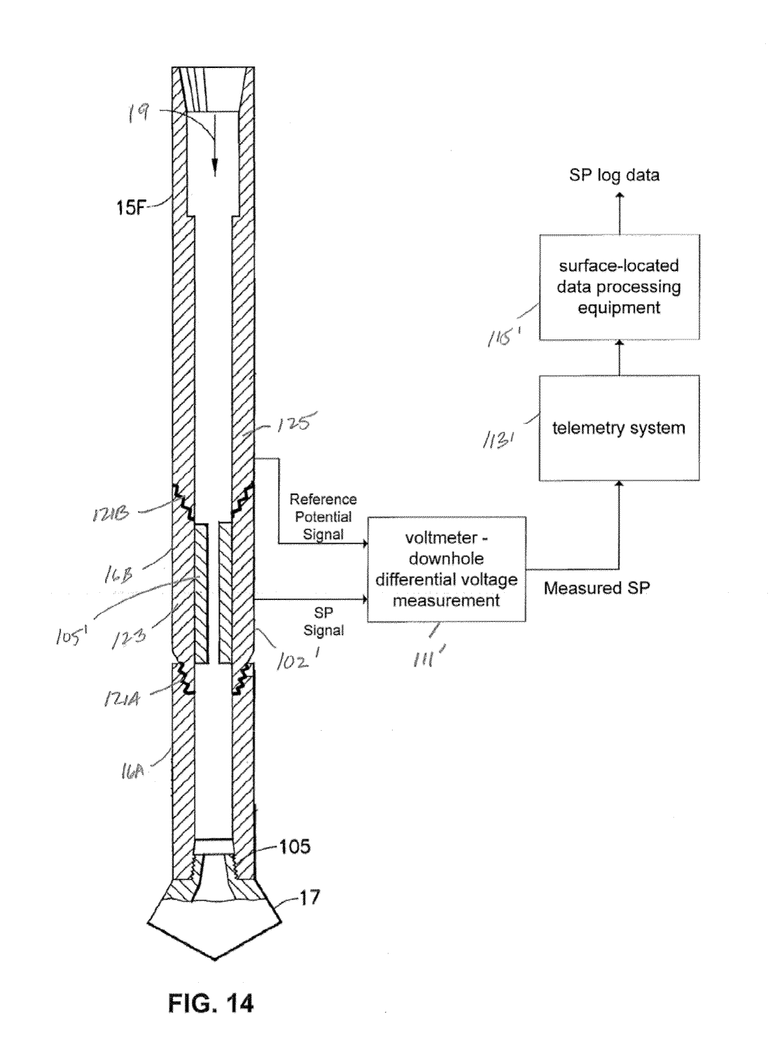

An alternate design for a while-drilling tool that acquires spontaneous potential measurements is shown in FIG. 14. In this design, a section of the drill string 14 (for example, a drill collar section 16B as shown) is electrically isolated from the drill bit 17 and the other sections of the drill string 15 by a pair of isolation joints 121A, 121B as shown. The annular body 123 of this isolated section of the drill string is used as the measurement electrode 102′. The annular body 125 of drill string section 15F behind this isolated section (and possibly sections of the drill string behind section 15F and coupled thereto) produces a reference DC potential signal. An annular chassis 105′ fits within the drill collar section 16B. The annular chassis 105′ houses insulated conductive wiring that is electrically coupled to the tubular body 123 (which is used as the measuring electrode 102′ for spontaneous potential measurements) and to the tubular body 125 of the drill string section 15F (which is used to generate a reference DC potential signal for spontaneous potential measurements). The annular chassis 105′ also preferably includes interface electronics and telemetry electronics which interface to a while-drilling telemetry system (such as a mud pulse telemetry system or electromagnetic (EM) frequency communication telemetry system) located in a separate drill collar (or possibly the same drill collar). The interface electronics includes a digital voltmeter (labeled as block 111′ in FIG. 14) whose inputs are connected to the insulated conductive wirings leading to the tubular body 123 (the measurement electrode 102′) and to the tubular body 125. The digital voltmeter 111 is configured to measure the differential DC voltage (current) between the tubular body 123 (the measurement electrode 102′) and the reference potential DC signal provided by the tubular body 125. Such differential voltage measurement (labeled “measured SP” in FIG. 14) is representative of the sum of the voltages from ionic diffusion (spontaneous potential) of the earth formation at the measurement electrode 102′ and possibly voltages from fluid movement (streaming potential) at the measurement electrode 102′. The other parts of the tool are the same as described above for the tool of FIG. 2.

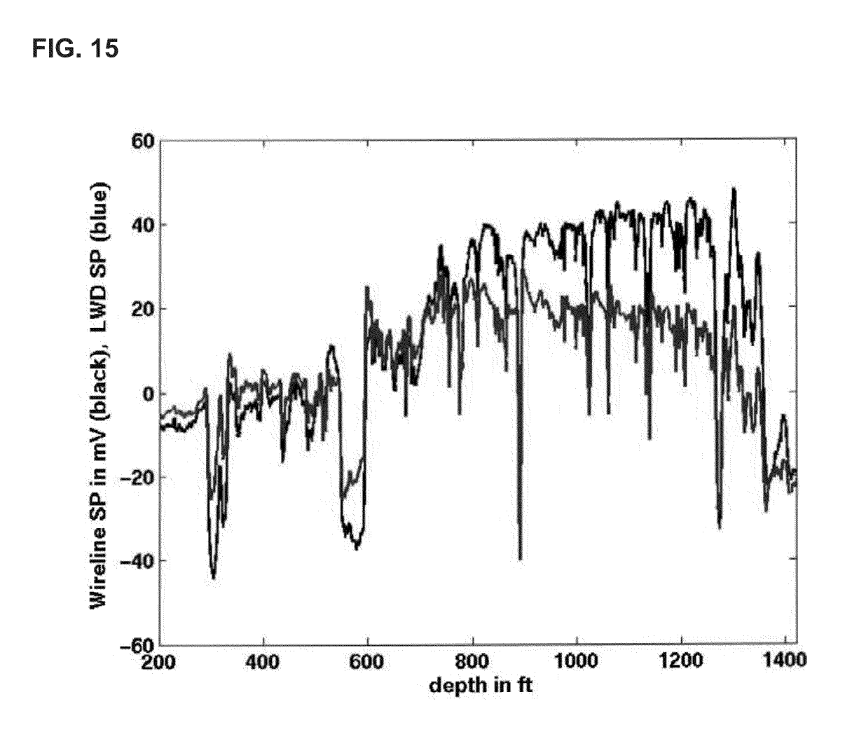

In an exemplary embodiment, the length of the annular body 123 of the isolated drill collar section 16B (i.e., the measurement electrode 102′) is 2 feet, and the distance between the isolated drill collar section 16B (i.e., the measurement electrode 102′) and the drill bit 17 is 60 feet, which is similar to the exemplary embodiment for the tool design of FIG. 2 as described above. A tool response model can be used to predict the measured SP data that would be acquired while-drilling by the tool of FIG. 14 in the Cartoosa test well. The prediction of the measured SP data while-drilling as output from the tool response model is shown as a curve in FIG. 15 in conjunction with the wireline SP data log shown as a second curve in FIG. 15. The depth for the first curve is the position of the isolated section of the drill string (i.e., measurement electrode), not the position of the drill bit 17. Apart from a baseline shift, the first curve and the second curve are quite similar, which shows that the while-drilling tool of FIG. 14 can be used to acquire SP log data.

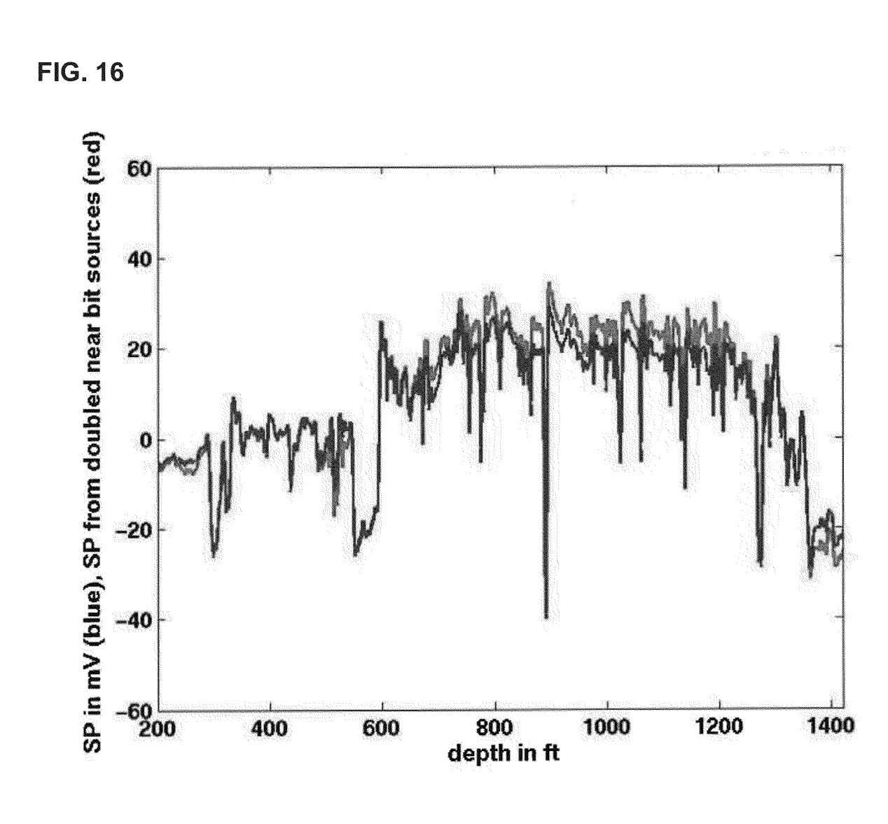

In order to test the sensitivity of the tool of FIG. 14 to voltage potential sources far away from the measurement electrode 102′, the tool response model can be modified by doubling the voltage potential sources in the 30 feet of the borehole just above the drill bit 17. The resulting SP data log for the predicted SP measurements acquired while-drilling by the tool of FIG. 14 is shown as the first curve in FIG. 16. The second curve of FIG. 16 shows the SP data log for the predicted SP measurements acquired while-drilling by the tool of FIG. 14 in the Cartoosa test well as output by the tool response model (the same as the first curve of FIG. 15). By comparing the second curve of FIG. 16 with the first curve of FIG. 13, the differences show that the tool of FIG. 14 is more sensitive to the voltage potential sources far away from the measurement electrode 102′. Therefore, it is more prone to streaming potential contamination.

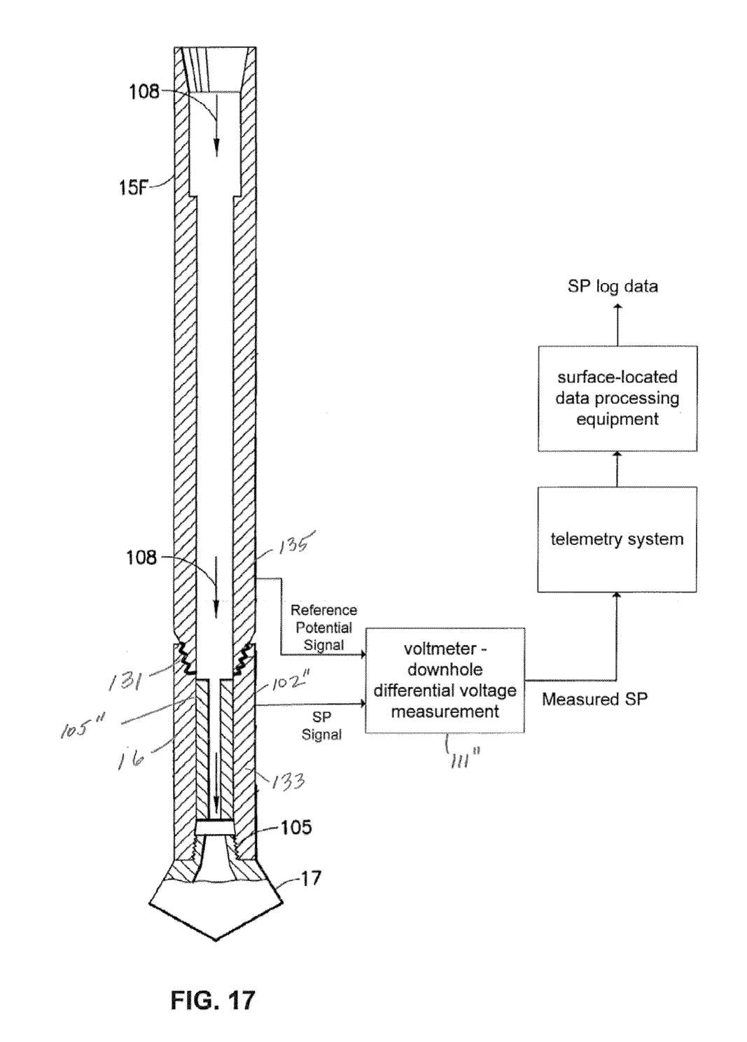

Another alternate design for a while-drilling tool that acquires spontaneous potential measurements is shown in FIG. 17. In this design, the drill string 14 includes a drill collar section 16 with an isolation joint 131 behind the drill bit 17 in order to electrically isolate the drill collar section 16 and the drill bit 17 from the parts of the drill string (including drill tubing section 15F) behind the isolation joint 131 as shown. The metal body 133 of the drill collar section 16 and the drill bit 17 disposed in front of the isolation joint 131 is used as the measurement electrode 102″. The metal body 135 of drill pipe section 15F as well as the metal body (not shown) of other parts of the drill string 14 that are electrically coupled thereto and disposed behind the isolation joint 131 produces a reference DC potential signal. An annular chassis 105″ fits within the drill collar section. The annular chassis 105″ houses insulated conductive wiring that is electrically coupled to the tubular body 133 (which is used as the measuring electrode 102″ for spontaneous potential measurements) and to the tubular body 135 of the drill string section 15F (which is used to generate a reference DC potential signal for spontaneous potential measurements). The annular chassis 105″ also preferably includes interface electronics and telemetry electronics which interface to a while-drilling telemetry system (such as a mud pulse telemetry system or electromagnetic (EM) frequency communication telemetry system) located in a separate drill collar (or possibly the same drill collar). The interface electronics includes a digital voltmeter (labeled as block 111″ in FIG. 17) whose inputs are connected to the insulated conductive wirings leading to the tubular body 133 (the measurement electrode 102″) and to the tubular body 135. The digital voltmeter 111 is configured to measure the differential DC voltage (current) between the tubular body 133 (the measurement electrode 102″) and the reference potential DC signal provided by the tubular body 135 as well as the metal body (not shown) of other parts of the drill string 14 that are electrically coupled thereto. Such differential voltage measurement (labeled “measured SP” in FIG. 17) is representative of the sum of the voltages from ionic diffusion (spontaneous potential) of the earth formation at the measurement electrode 102″ and possibly voltages from fluid movement (streaming potential) at the measurement electrode 102″. The other parts of the tool are the same as described above for the tool of FIG. 2.

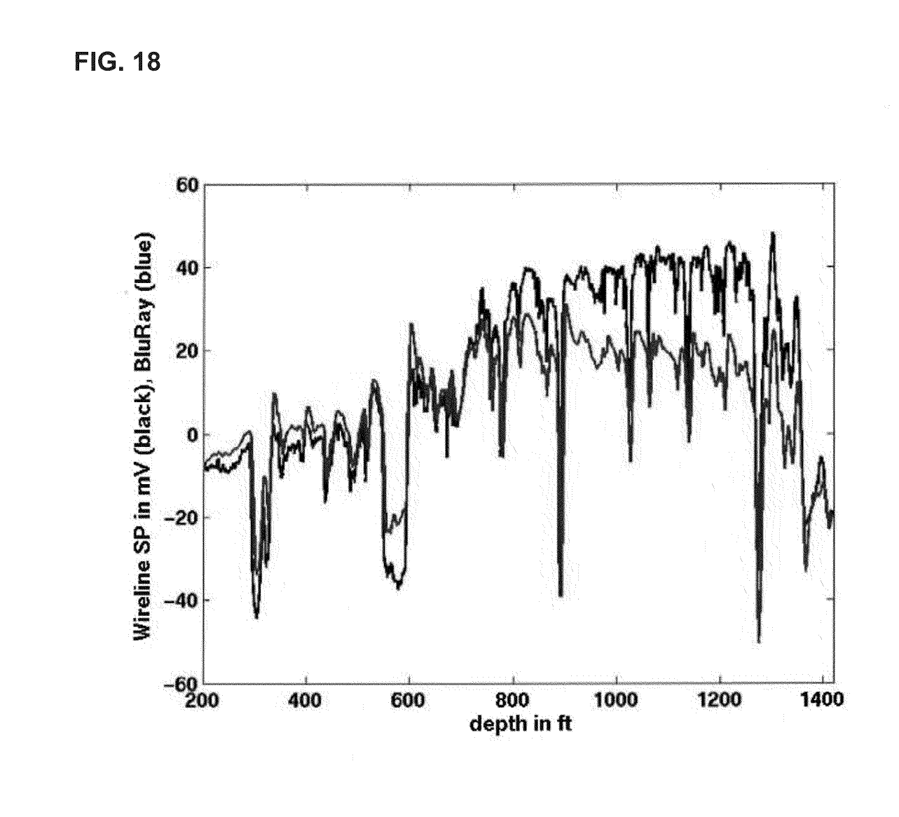

In an exemplary embodiment, the length of the body of the drill collar section 16 in front of the isolation joint 131 (i.e., the measurement electrode 102″) is 6 feet. A tool response model can be used to predict the measured SP data that would be acquired while-drilling by the tool of FIG. 17 in the Cartoosa test well. The prediction of the measured SP data while-drilling as output from the tool response model is shown as the curve in FIG. 18 in conjunction with the wireline SP data log shown as the second curve in FIG. 18. It can be seen that these two curves are again very similar (just as are the two curves of FIG. 6). Upon more careful examination, it can be seen that the spatial resolution of the first curve of FIG. 18 is lower than that of the second curve in FIG. 18. This is due to the fact that the spatial resolution of the tool of FIG. 17 is limited by the distance from the isolation joint 131 to the drill bit 17 (e.g., 6 feet in the exemplary embodiment). Note that it would be very difficult to shrink this distance to improve the spatial resolution. Also note that the contribution of streaming potential to the spontaneous potential measured by the tool of FIG. 17 is likely to be quite complex, even if the spontaneous potential measurements are acquired during tripping. Such streaming potential contributions can contaminate the spontaneous potential measurements.

The differential voltage measuring circuitry (voltmeter) of the while-drilling tools described herein provide for high input impedance in order to measure DC potentials in millivolts. The modeling calculations described above were carried out for conductive mud. Many while-drilling logs are acquired while-drilling with oil-based mud. The while-drilling tools described herein will work in oil-based mud so long as the impedance between the measurement electrode and the drill string reference is significantly lower than the input impedance of the measuring circuit (voltmeter). The drill string reference has a very large surface area, so its surface impedance is not a problem. For oil-based mud, the measurement electrode has to have a sufficiently large surface area and the input impedance of the measuring circuit (voltmeter) must be sufficiently high.

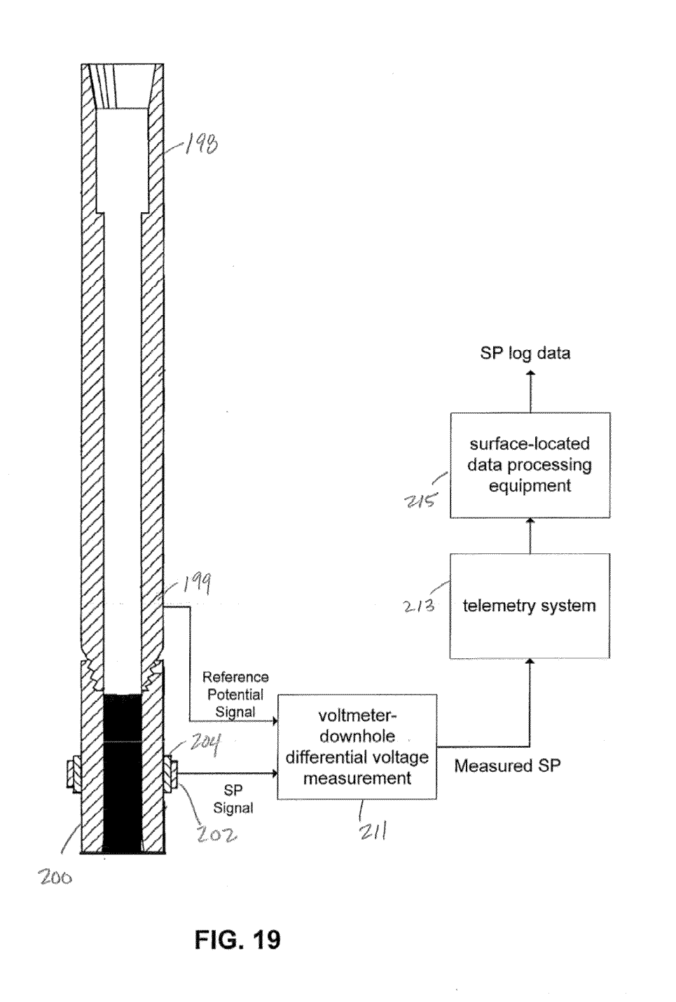

The principles described herein can be applied to wireline logging tools for tough logging conditions (TLC). In such TLC wireline logging tools, the wireline tool has a tool body (sonde) 200 that is suspended from a drill string 198 as shown in FIG. 19. The tool body 200 can have multiple parts or modules (not shown) that are mechanically coupled to one another. In such applications, the TLC wireline logging tool can be adapted to acquire spontaneous potential measurements. The improved TLC wireline logging tool employs an electrode 202 (preferably annular in shape) supported on an insulating sleeve 204 (also preferably annular in shape) that surrounds or otherwise overlies the tool body 200. The insulating sleeve 204 is realized from an electrically insulating material [such as a high temperature fiberglass, ceramics (e.g., zirconia and/or transformation toughened zirconia (TTZ)), high temperature thermoplastic (e.g., PEEK, PEKK, virgin or fiber reinforced), epoxy paint, rubber, and/or hybrid combinations of these materials (metamaterials)]. The insulating sleeve 204 electrically isolates the electrode 202 from the tool body 200 and the drill string 198 mechanically coupled thereto. It thus allows the body 199 of the drill string 198 (as well as the body of other parts of the drill string electrically connected thereto) to be used to generate a reference DC potential signal for spontaneous potential measurements as described below in more detail. The tool body 200 houses insulated conductive wiring that is electrically coupled via an insulated feed-through (not shown) to the electrode 202 (which is used as a measuring electrode for spontaneous potential measurements) and to the metal tubular body 199 of the drill string 198 (which is used to generate a reference DC potential signal for spontaneous potential measurements). The tool body 200 also preferably includes interface electronics and a telemetry system (such as a wired telemetry system utilizing cabling that extends at least partially through the drill string 198 or an electromagnetic (EM) frequency communication telemetry system). The interface electronics of the tool body 200 includes a digital voltmeter (labeled as block 211 in FIG. 19) whose inputs are connected to the insulated conductive wirings leading to the measurement electrode 202 and to the tubular body 199. The digital voltmeter 111 is configured to measure the differential DC voltage (current) between the potential of the measurement electrode 202 and the reference potential DC signal provided by the tubular body 199 as well as the metal body (not shown) of other parts of the drill string that are electrically coupled thereto. Such differential voltage measurement (labeled “measured SP” in FIG. 18) is representative of the sum of the voltages from ionic diffusion (spontaneous potential) of the earth formation at the measurement electrode 202 and possibly voltages from fluid movement (streaming potential) at the measurement electrode 202. The telemetry system (labeled as block 213 in FIG. 19) communicates the measured downhole data to surface-located data processing equipment 215 (e.g., a processor and associated data storage). The telemetry system 213 encodes the downhole measurements (including the measured SP data), which are decoded by the surface-located data processing equipment 215. The surface-located data processing equipment 215 receives data signals representative of the downhole measurements (including the measured SP data) and processes the data signals representative of the measured SP data to derive spontaneous potential (SP) log data for storage and analysis.

It is also contemplated that the TLC wireline logging tools described herein can derive and store data representing the downhole SP measurements in a memory system that is part of the downhole tool body. At the surface, the stored data is read from the memory system of the tool body and can be correlated to a depth-time reference log, if need be.

It is also contemplated that the TLC wireline logging tool as described above can be conveyed by other electrically conducting conveyance means such as coil tubing and the like where the body of the tool conveyance means is used to generate a reference DC potential signal for spontaneous potential measurements as described herein.

While particular embodiments have been described, it is not intended that the claims be limited thereto, as it is intended that the claims be as broad in scope as the art will allow and that the specification be read likewise. Thus, while particular downhole tools have been disclosed, it will be appreciated that other downhole tools can embody the capabilities of measuring spontaneous potential as described herein. Furthermore, while particular modeling methodologies and data processing analysis has been described for deriving spontaneous potential logs from downhole spontaneous potential measurements, it will be understood that other inversion methodologies and data processing analysis can be similarly used. For example, the downhole logging tools described herein can employ downhole data processing equipment that carries out some or all of the data processing functions as described above for the surface-located data processing equipment. It will therefore be appreciated by those skilled in the art that yet other modifications could be made to the provided embodiments without deviating from the scope of the claims.

What is claimed is:

1. Apparatus for measuring spontaneous potential of an earth formation traversed by a borehole, comprising:
a) a downhole tool comprising tool conveyance means for movement within the borehole, wherein a portion of the tool conveyance means produces a reference DC potential signal;
b) a measurement electrode that is part of the downhole tool, wherein the measurement electrode produces a potential signal representative of spontaneous potential of the earth formation adjacent the measurement electrode; and
c) downhole voltage measurement circuitry that is part of the downhole tool,
wherein the downhole voltage measurement circuitry measures a differential DC potential signal between the potential signal produced by the measurement electrode and the reference DC potential signal produced by the drill string portion, and
wherein spontaneous potential data that characterizes spontaneous potential of the earth formation adjacent the measurement electrode is based upon the differential DC potential signal measured by said downhole voltage measurement circuitry.

2. Apparatus according to claim 1, wherein the tool conveyance means comprises a drill string.

3. Apparatus according to claim 2, further comprising a drill bit connected to the drill string.

4. Apparatus according to claim 3, wherein the drill string further includes a telemetry system for communicating data signals to a surface-located data processing system, wherein the data signals are based upon the output of said voltage measurement circuitry.

5. Apparatus according to claim 1, further comprising a first insulated conductor electrically coupled between the voltage measurement circuitry and the portion of the tool conveyance means that produces the reference DC potential signal; and a second insulated conductor electrically coupled between the voltage measurement circuitry and the measurement electrode.

6. Apparatus according to claim 1, wherein the downhole tool includes an insulative sleeve that supports the measurement electrode, wherein the insulative sleeve electrically isolates the measurement electrode from the portion of the tool conveyance means that produces the reference DC potential signal.

7. Apparatus according to claim 6, wherein both the measurement electrode and the insulating sleeve are annular in shape.

8. Apparatus according to claim 1, wherein both the tool conveyance means and the downhole tool are realized by a drill string including a first portion electrically isolated from a second portion, the first portion being disposed behind the second portion; wherein the first portion produces the reference DC potential signal, and the measurement electrode comprises the second portion.

9. Apparatus according to claim 8, wherein the drill string comprises first and second insulative joints disposed on opposed ends of the second portion, the first insulative joint electrically isolating the second portion of the drill string from other parts of drill string disposed behind the second portion, and the second insulative joint electrically isolating the second portion of the drill string from other parts of drill string disposed forward the second portion.

10. Apparatus according to claim 8, wherein the drill string comprises an insulative joint that electrically isolates the first portion from the second portion.

11. Apparatus according to claim 10, wherein the insulative joint mechanically connects the first and second portions of the drill string.

12. Apparatus according to claim 8, further comprising a drill bit mechanically connected to the second portion of the drill string, wherein the measurement electrode further comprises the drill bit.

13. Apparatus according to claim 1, wherein the tool conveyance means is realized by a drill string including at least one drill collar that produces the reference DC potential signal.

14. Apparatus according to claim 1, wherein the voltage measurement circuitry is housed in an annular chassis that allows for passage of drilling fluid therethrough.

15. Apparatus according to claim 1, wherein the downhole tool includes a tool body supported by the tool conveyance means; and the measurement electrode is supported on the tool body.

16. Apparatus according to claim 15, wherein the tool body includes an insulative sleeve that supports the measurement electrode and electrically isolates the measurement electrode from the tool body.

17. Apparatus according to claim 1, further comprising data processing circuitry for generation, storage, and output of spontaneous potential data that characterizes spontaneous potential of the earth formation adjacent the measurement electrode at different locations in the borehole, wherein the spontaneous potential data is based upon the differential DC potential signal measured by said voltage measurement circuitry.

18. Apparatus according to claim 17, wherein the data processing circuitry is located at the surface of the earth formation.

19. Apparatus according to claim 17, wherein the data processing circuitry is supported by the tool conveyance means and moves with the tool conveyance means in the borehole.

20. Apparatus according to claim 17, wherein the data processing circuitry processes the data representing the differential DC potential signals measured by said voltage measurement circuitry with a model that compensates for variations in such differential DC potential signals as compared to traditional spontaneous potential measurements with wireline logging tools that utilize a surface-located reference electrode.

21. Apparatus according to claim 20, wherein the model is configured reduce distortions in such differential DC potential signals as compared to traditional spontaneous potential measurements with wireline logging tools that utilize a surface-located reference electrode.

22. Apparatus according to claim 20, wherein the model is configured to restore baseline shift in such differential DC potential signals as compared to traditional spontaneous potential measurements with wireline logging tools that utilize a surface-located reference electrode.

23. A while-drilling apparatus for measuring spontaneous potential of an earth formation traversed by a borehole, comprising:
a) a downhole tool including a drilling bit, the downhole tool moveable within the borehole by a drill string, wherein a portion of the drill string produces a reference DC potential signal;
b) a measurement electrode that is part of the downhole tool, wherein the measurement electrode produces a potential signal representative of spontaneous potential of the earth formation adjacent the measurement electrode; and
c) downhole voltage measurement circuitry that is part of the downhole tool, wherein the downhole voltage measurement circuitry measures a differential DC potential signal between the potential signal produced by the measurement electrode and the reference DC potential signal produced by the drill string portion, and wherein spontaneous potential data that characterizes spontaneous potential of the earth formation adjacent the measurement electrode is based upon the differential DC potential signal measured by said downhole voltage measurement circuitry.

24. A while-drilling apparatus according to claim 23, wherein the drill string has an insulative sleeve that supports the measurement electrode.

25. A while-drilling apparatus according to claim 23, wherein the drill string includes at least one drill collar that produces the reference DC potential signal.
